(19) United States
(12) Patent Application Publication
(10) Pub. No.: US 2019/0108484 A1
(43) Pub. Date: Apr. 11, 2019

(54) REAL-TIME MESSAGING SYSTEM

(71) Applicant: TOSHIBA TEC KABUSHIKI KAISHA, Tokyo (JP)

(72) Inventor: Akiko WATANABE, Sunto Shizuoka (JP)

(21) Appl. No.: 16/156,196

(22) Filed: Oct. 10, 2018

(30) Foreign Application Priority Data
Oct. 11, 2017 (JP) 2017-197943

(51) Int. Cl. G06Q 10/08; G06Q 20/20; H04L 29/08

(52) U.S. Cl. CPC G06Q 10/0875; H04L 67/26; G06Q 20/203

(57) ABSTRACT

A real-time messaging system includes a store server configured to track items that are displayed on store shelves by item code and quantity and the items that are not displayed but available in inventory by item code and quantity, and a plurality of portable terminals configured to provide the store server updates to the quantities of the items that are displayed and the items that are in inventory, when one or more items in the inventory are moved for display onto the store shelves and code and quantity of each of the moved items are input using the portable terminals. The store server, in response to the updates, generates a message in real-time regarding an item that has been moved for display and transmits the message to one or more target destinations.

### CROSS-REFERENCE TO RELATED APPLICATION

This application is based upon and claims the benefit of priority from Japanese Patent Application No. 2017-197943, filed on Oct. 11, 2017, the entire contents of which are incorporated herein by reference.

### FIELD

Embodiments described herein relate generally to a real-time messaging system.

### BACKGROUND

In the related art, in stores such as a supermarket, messages are communicated to a customer to prompt the customer to perform a store visit and make a purchase.

However, according to messaging systems of the related art, information to be sent to the customer is set in advance and there is a problem that it is not possible to timely transmit to the customer real-time information about commodities that have just been displayed on a shelf in the store, or about price cuts on commodities that have just been implemented.

### DESCRIPTION OF THE DRAWINGS

FIG. 1 is a block diagram illustrating a configuration of a real-time messaging system according to an embodiment.

FIG. 2 is a block diagram illustrating a hardware configuration of a portable terminal.

FIG. 3 is a diagram illustrating one example of a data configuration which is stored in an information table of commodity which is being displayed on the store shelf.

FIG. 4 is a block diagram illustrating a hardware configuration of a store server.

FIG. 5 is a diagram illustrating one example of a data configuration which is stored in a display master file.

FIG. 6 is a diagram illustrating one example of a data configuration which is stored in a commodity master file.

FIG. 7A and FIG. 7B are diagrams illustrating one example of a data configuration which is stored in a customer master file.

FIG. 8 is a functional block diagram illustrating a functional components of the real-time messaging system.

FIG. 9 is a flowchart illustrating a method of updating information of commodity which is currently being displayed.

FIG. 10 is a flowchart illustrating a real-time messaging method according to an embodiment.

### DETAILED DESCRIPTION

In order to solve the problems, embodiments described herein provides a real-time messaging system capable of timely transmitting information on commodities that are currently being displayed.

In general, according to one embodiment, there is provided a real-time messaging system including a store server configured to track items that are displayed on store shelves by item code and quantity and the items that are not displayed but available in inventory by item code and quantity, and a plurality of portable terminals configured to provide the store server updates to the quantities of the items that are displayed and the items that are in inventory, when one or more items in the inventory are moved for display onto the store shelves and code and quantity of each of the moved items are input using the portable terminals. The store server, in response to the updates, generates a message in real-time regarding an item that has been moved for display and transmits the message to one or more target destinations.

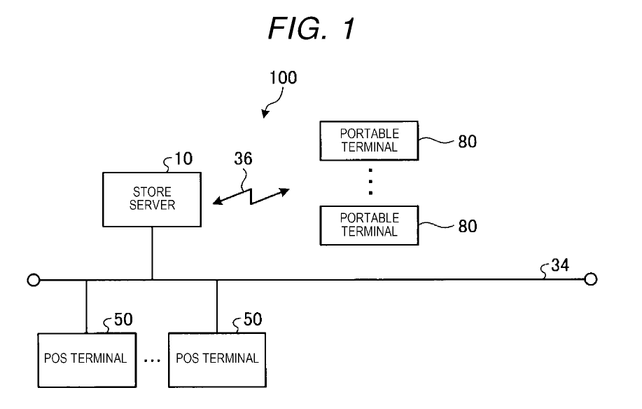

FIG. 1 is a block diagram illustrating a configuration of a real-time messaging system 100 according to one embodiment. The real-time messaging system 100 illustrated in FIG. 1 communicates real-time information relating to a commodity at the time of displaying of the commodity, in addition to any message set in advance.

As illustrated in FIG. 1, the real-time messaging system 100 includes a store server 10 which is an information processing apparatus, a plurality of point of sales (POS) terminals 50, and a plurality of portable terminals 80.

The store server 10 and the POS terminal 50 are connected to each other to be capable of communicating with each other by a communication network 34 such as a local area network (LAN). The store server 10 and the portable terminal 80 are connected to each other to be capable of communicating with each other by wireless communication 36 such as a wireless LAN.

The store server 10 is provided in a backyard (or back office) or the like of the store, for example. The store server 10 performs management of commodity information, customer information, and information of commodity which is currently being displayed (hereinafter, referred to as “display commodity information”) at the store. The store server 10 requests a salesperson who performs the displaying of the commodity so as to replenish the commodity currently displayed on the store shelf, on condition that the number of displayed commodities is less than a predetermined value.

Furthermore, the store server 10 communicates a message containing real-time information relating to the displaying of the commodity, to an electronic device (which is not illustrated in the drawing) such as a smartphone or a mobile phone that is carried by a predetermined customer, at the timing of the displaying.

The plurality of POS terminals 50 are provided in the store. The POS terminal 50 performs commodity registration processing and checkout processing of the commodity which is purchased by the customer.

The portable terminals 80 are carried one by one, respectively, by a plurality of salespersons who perform the displaying of the commodity in the store. The portable terminal 80 transmits the information regarding the commodity, which needs to be displayed, to the salesperson, for example, based on a command from the store server 10.

### Description of Hardware Configuration of Portable Terminal

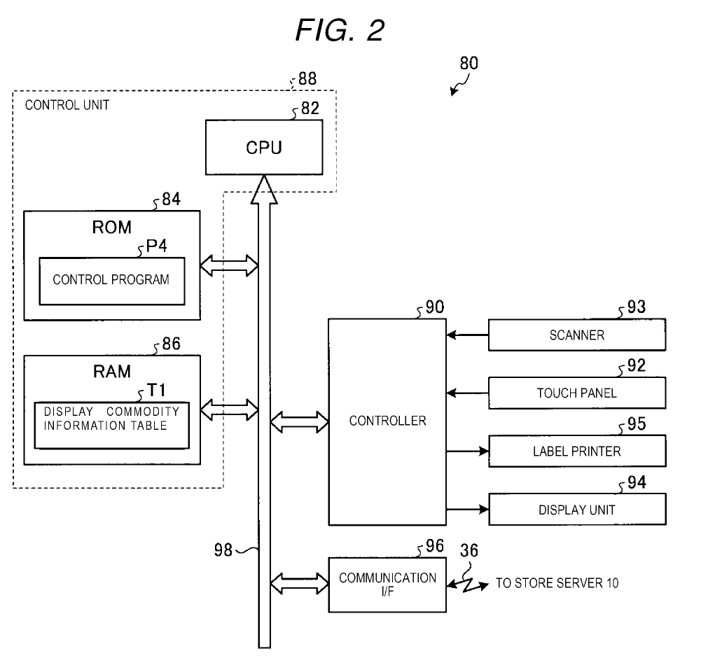

First, a hardware configuration of the portable terminal 80 will be described. FIG. 2 is a block diagram illustrating the hardware configuration of the portable terminal 80.

As illustrated in FIG. 2, the portable terminal 80 includes a control unit 88 having a computer configuration which includes a central processing unit (CPU) 82, a read only memory (ROM) 84, a random access memory (RAM) 86, and the like. The CPU 82 executes various arithmetic processing, and controls each unit. The ROM 84 stores and saves fixed data in a read-only manner. The RAM 86 is used as a work area in which variable data is stored in a rewritable manner. The CPU 82, the ROM 84, and the RAM 86 are connected to each other through an internal bus 98.

A control program P4 which is executed by the portable terminal 80 is stored in the ROM 84, for example.

The control program P4 which is executed by the portable terminal 80 is provided by being recorded in a recording medium which is readable by a computer, for example, a CD-ROM, a flexible disk (FD), a CD-R, a digital versatile disc (DVD) or the like, in a file of an installable format or an executable format.

The control program. P4 which is executed by the portable terminal 80 may be configured to be provided by being stored on the computer which is connected to a network such as the Internet, or by being downloaded through the network. Furthermore, the control program P4 which is executed by the portable terminal 80 may be provided or distributed through the network such as the Internet. The control program P4 which is executed by the portable terminal 80 may be provided by being stored in the ROM 84 in advance.

A display unit 94 and a touch panel 92 are connected to the portable terminal 80, through a controller 90. The display unit 94 displays the information which is output by the portable terminal 80. The touch panel 92 receives an input of an operation command with respect to the portable terminal 80. All of operations of peripheral devices are controlled by the control unit 88.

A scanner 93 and a label printer 95 are connected to the portable terminal 80, through the controller 90. For example, the scanner 93 reads a barcode that is attached to the commodity of which the displaying is performed. The label printer 95 issues a label.

Furthermore, the portable terminal 80 includes a communication I/F 96 for performing data communication with the store server 10 through the wireless communication 36. The communication I/F 96 is also connected to the internal bus 98.

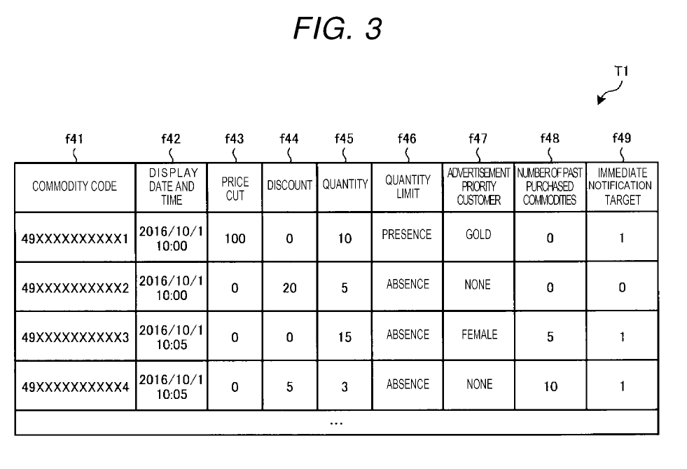

The RAM 86 includes an information table of commodity which is currently being displayed on the store shelf (hereinafter, referred to as “display commodity information table”) that stores the display commodity information which is input by the salesperson who performs the displaying of the commodity. Here, FIG. 3 is a diagram illustrating an example of a data configuration which is stored in a display commodity information table T1.

As illustrated in FIG. 3, the display commodity information table T1 includes a commodity code f41, a displaying date and time f42, a price cut f43, a discount rate f44, a quantity f45, a quantity limit f46, an advertisement priority customer f47, a number of past purchased commodities f48, and an immediate notification target f49.

The commodity code f41 stores a commodity code of each commodity of which the displaying is performed. The displaying date and time f42 stores the date and time at which the displaying of the commodity is performed.

The price cut f43 stores an amount of money of a price cut for the commodity of which the displaying is performed. The discount rate f44 stores a discount rate for the commodity of which the displaying is performed.

The quantity f45 stores a quantity of the commodity which needs to be displayed. The quantity limit f46 stores whether or not there is a limit on the quantity of the commodity which becomes a target of the price cut or the discount, when the amount of money of the price cut is stored in the price cut f43, or when the discount rate is stored in the discount rate f44.

The advertisement priority customer f47 indicates a category of customers who are preferentially notified of the display advertisement. For example, there are customer categories based on rank, age, gender, and the like.

The number of past purchased commodities f48 indicates the minimum number of commodities that a customer need to have purchased in the past, in order for the customer to be the target of the display advertisement.

The immediate notification target f49 stores a flag that indicates whether or not the commodity is a target for immediate notification. For example, the flag is “1” when the commodity is a target for immediate notification, and the flag is “0” when the commodity is not a target for immediate notification.

### Description of Hardware Configuration of Store Server

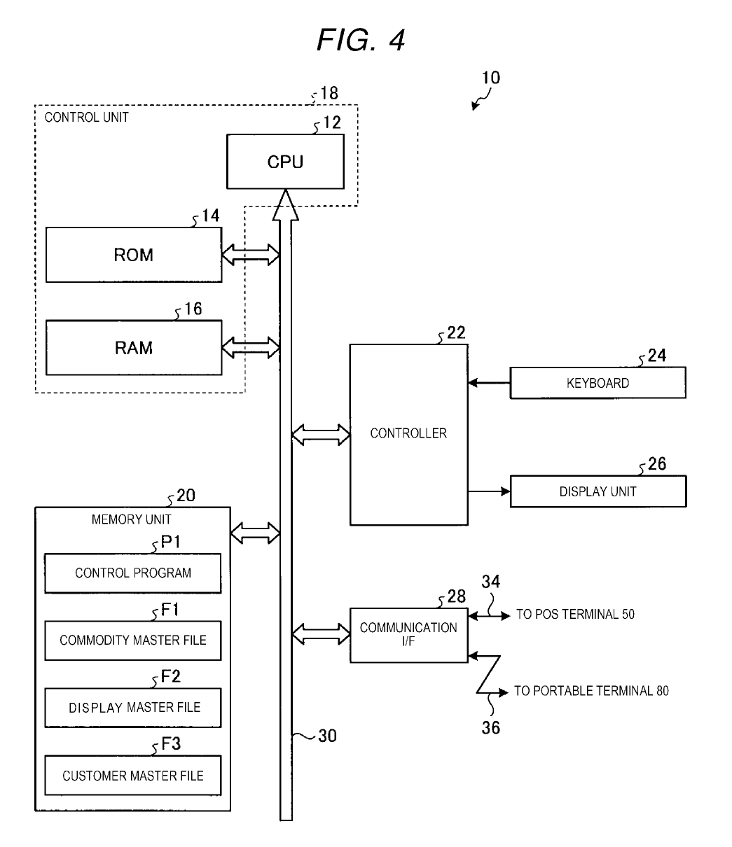

Next, a hardware configuration of the store server 10 will be described. FIG. 4 is a block diagram illustrating the hardware configuration of the store server 10.

As illustrated in FIG. 4, the store server 10 includes a control unit 18 having a computer configuration that includes a central processing unit (CPU) 12, a read only memory (ROM) 14, a random access memory (RAM) 16, and the like. The CPU 12 executes various arithmetic processing, and controls each unit. The ROM 14 stores and saves fixed data in a read-only manner. The RAM 16 is used as a work area in which variable data is stored in a rewritable manner. The CPU 12, the ROM 14, and the RAM 16 are connected to each other through an internal bus 30.

A keyboard 24 and a display unit 26, which are peripheral devices, are connected to the store server 10 through a controller 22. All of the operations of the peripheral devices are controlled by the control unit 18. The keyboard 24 receives the input of the operation command with respect to the store server 10. The display unit 26 displays the information which is output by the store server 10.

Furthermore, the store server 10 includes a communication interface (I/F) 28 for performing the data communication with the POS terminal 50, through the communication network 34 which is provided in the store. The communication I/F 28 has a function of performing communication with the store server 10 and the portable terminal 80 through the wireless communication 36. The communication I/F 28 is also connected to the internal bus 30.

Moreover, a memory unit 20 which is a storage device is connected to the control unit 18, through the internal bus 30. For example, the memory unit 20 includes a hard disk drive (HDD), a flash memory, or the like, and retains stored contents even when a power source is cut off.

The memory unit 20 stores various master data of a control program P1 such as an operating system or various computer programs, a commodity master file F1, a display master file F2, and a customer master file F3.

The control program P1 which is executed by the store server 10 is provided by being recorded in a recording medium which is readable by a computer, for example, a CD-ROM, a flexible disk (FD), a CD-R, a digital versatile disc (DVD) or the like, in a file of an installable format or an executable format.

The control program P1 which is executed by the store server 10 may be configured to be provided by being stored on the computer which is connected to the network such as the Internet, or by being downloaded through the network. Furthermore, the control program P1 which is executed by the store server 10 may be provided or distributed through the network such as the Internet. The control program P1 which is executed in the store server 10 may be provided by being stored in the ROM 14 in advance.

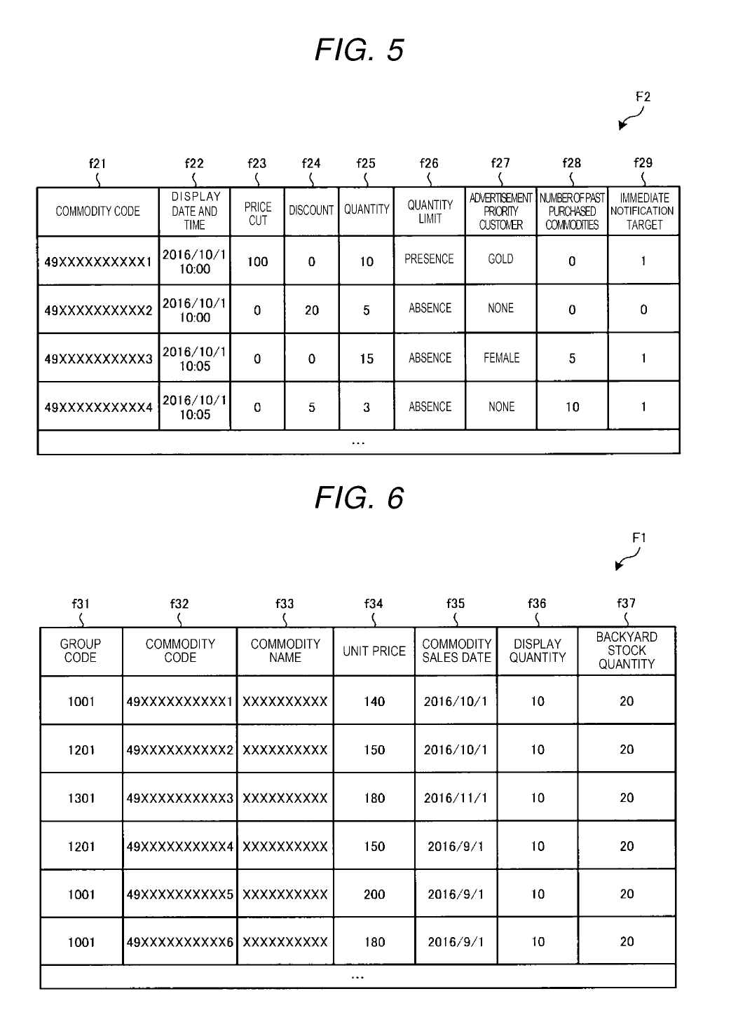

First, the display master file F2 will be described. FIG. 5 is a diagram illustrating an example of a data configuration which is stored in the display master file F2. The display master file F2 is a master file which is received from the portable terminal 80 by the store server 10, and includes the display commodity information of the display commodity information table T1 (see FIG. 3) that is input by the salesperson who performs the displaying.

As illustrated in FIG. 5, the display master file F2 includes a commodity code f21, a displaying date and time f22, a price cut f23, a discount rate f24, a quantity f25, a quantity limit f26, an advertisement priority customer f27, a number of past purchased commodities f28, and an immediate notification target f29.

The commodity code f21 stores a commodity code of each commodity. The displaying date and time f22 stores the date and time at which the displaying of the commodity is performed.

The price cut f23 stores an amount of money of a price cut for the commodity of which the displaying is performed. The discount rate f24 stores a discount rate for the commodity of which the displaying is performed.

The quantity f25 stores a quantity of the commodity which needs to be displayed. The quantity limit f26 stores whether or not there is the limit on the quantity of the commodity which becomes the target of the price cut or the discount, when the amount of money of the price cut is stored in the price cut f23, or when the discount rate is stored in the discount rate f24.

The advertisement priority customer f27 indicates a category of customers who are preferentially notified of the display advertisement. For example, there are customer categories based on rank, an age, a gender, and the like.

The number of past purchased commodities f28 indicates the minimum number of commodities that a customer need to have purchased in the past, in order for the customer to be the target of the display advertisement.

The immediate notification target f29 stores a flag that indicates whether or not the commodity is an immediate target for notification. For example, the flag is “1” when the commodity is an immediate target for notification, and the flag is “0” when the commodity is not an immediate target for notification.

Next, the commodity master file F1 will be described. FIG. 6 is a diagram illustrating an example of a data configuration which is stored in the commodity master file F1. The commodity master file F1 is a master file in which the commodity information of all commodities that are sold at the store is registered.

As illustrated in FIG. 6, the commodity master file F1 includes a group code f31, a commodity code f32, a commodity name f33, a unit price f34, a commodity sales date f35, a display quantity f36, a backyard stock quantity f37.

The group code f31 stores an identification number which is assigned per group of commodities. The commodity code f32 stores an identification number which is assigned per commodity.

The commodity name f33 stores a name of each commodity. The unit price f34 stores a unit price of each commodity. The commodity sales date f35 stores the latest sales date of each commodity.

The display quantity f36 stores a quantity of commodities which are currently being displayed on a store shelf. The backyard stock quantity f37 stores a quantity of commodities which are currently stocked in the backyard.

Numerical values which are stored in the display quantity f36 and the backyard stock quantity f37 are appropriately updated. Specifically, the numerical value of the display quantity f36 is updated, according to the number of sales of the commodity whenever the store server 10 receives a transaction file which is updated every time the checkout processing is completed from the POS terminal 50. The numerical value of the backyard stock quantity f37 is updated whenever the store server 10 receives the commodity code and the quantity of the commodity which is currently being displayed that is included in the display commodity information table T1 (see FIG. 3), which is input to the portable terminal 80 by the salesperson who performs the displaying.

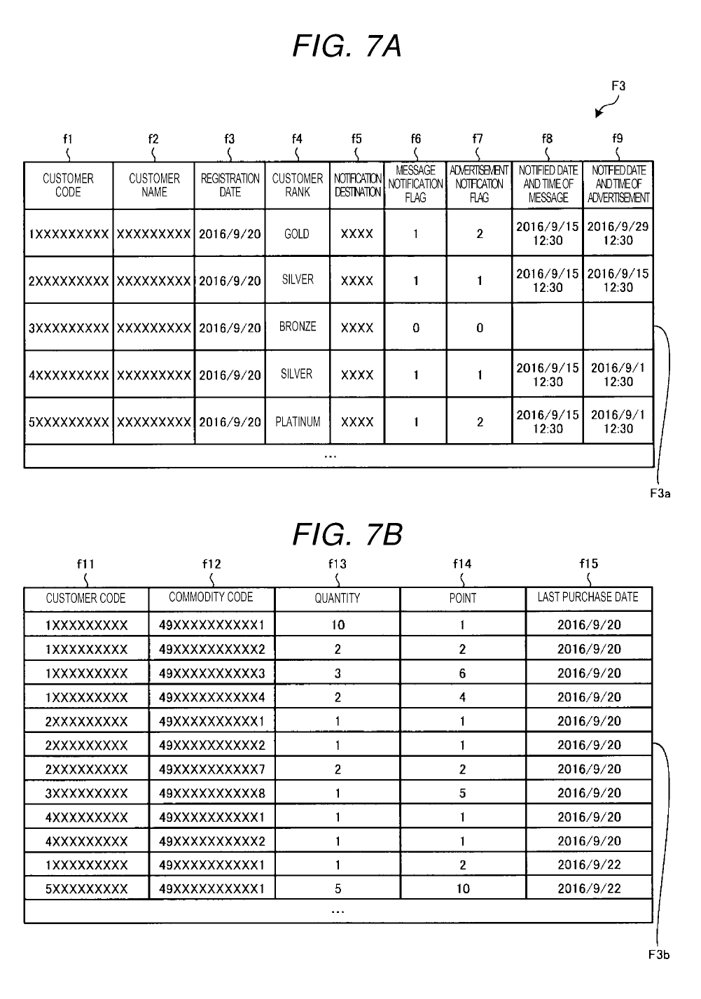

Next, the customer master file F3 will be described. FIG. 7A and FIG. 7B are diagrams illustrating an example of a data configuration which is stored in the customer master file F3. The customer master file F3 is a master file in which the customer information is registered. That is, the customer master file F3 includes the information such as a customer code, a customer name, a customer rank, a purchase history of each customer, and the like, as customer information.

As illustrated in FIG. 7A and FIG. 7B, the customer master file F3 includes customer attribute information F3a, and purchase history information F3b. As illustrated in FIG. 7A, the customer attribute information F3a is a database that stores attribute information which is necessary for specifying the customer. As illustrated in FIG. 7B, the purchase history information F3b is a database that stores the past purchase history of the customer.

As illustrated in FIG. 7A, the customer attribute information F3a includes a customer code f1, a customer name f2, a registration date f3, a customer rank f4, a notification destination f5, a message notification flag f6, an advertisement notification flag f7, a notified date and time of the message f8, and a notified date and time of the advertisement f9. Although not illustrated in FIG. 7A, the customer attribute information F3a may be stored in combination with the age, the gender, and the like of the customer.

The customer code f1 stores an identification number which is assigned per registered customer. The customer name f2 stores the first and last name of each customer.

The registration date f3 stores a registration date per registered customer. The customer rank f4 stores a customer rank of the customer. For example, the customer rank is gold, silver, bronze, or the like. For example, gold is a customer rank of the customer who is a regular customer of which a past aggregate payment exceeds a predetermined value in the store.

The notification destination f5 stores a notification destination of a normal message or a normal display advertisement message. For example, the notification destination of the normal message or the normal display advertisement message is an e-mail address, an account ID of the social networking service (SNS), or the like.

The message notification flag f6 stores a flag that indicates whether or not the notification of the message from the store is desired by the customer. For example, the flag is “1” when the notification of the message from the store is desired by the customer, and the flag is “0” when the notification of the message from the store is not desired by the customer.

The advertisement notification flag f7 stores a flag that indicates whether or not the notification of the display advertisement message from the store is desired by the customer. For example, the flag is “2” when the notification of the display advertisement message from the store is desired by the customer regarding the commodity which was purchased in the past, the flag is “1” when the notification of the display advertisement message from the store is desired by the customer, and the flag is “0” when the notification of the display advertisement message from the store is not desired by the customer.

The notified date and time of the message f8 stores the latest date and time at which the message is notified from the store. The notified date and time of the advertisement f9 stores the latest date and time at which the display advertisement message is notified from the store.

As illustrated in FIG. 7B, the purchase history information F3b includes a customer code f11, a commodity code f12, a quantity f13, a point f14, and a last purchase date f15.

The customer code f11 stores an identification number which is assigned per customer. The commodity code f12 stores a commodity code which is purchased by the customer.

The quantity f13 stores a total quantity of the commodity which has been purchased by the customer. The point f14 stores a point relating to the total amount of money of sales for the commodity which has been purchased by the customer. The last purchase date f15 stores the last date of the dates at which the customer purchased the commodities.

Both of the customer attribute information F3a and the purchase history information F3b which are included in the customer master file F3, are stored in a so-called relational database. That is, the information which is registered in the customer attribute information F3a, and the information which is registered in the purchase history information F3b are associated with each other. Accordingly, information retrieval is performed on the information which is stored in the customer master file F3, thereby, it is possible to easily extract various information on a specific customer. For example, it is possible to easily perform a retrieval operation of “commodity which was purchased by a certain customer over the last year” or the like.

### Description of Functional Configuration of Real-Time Messaging System

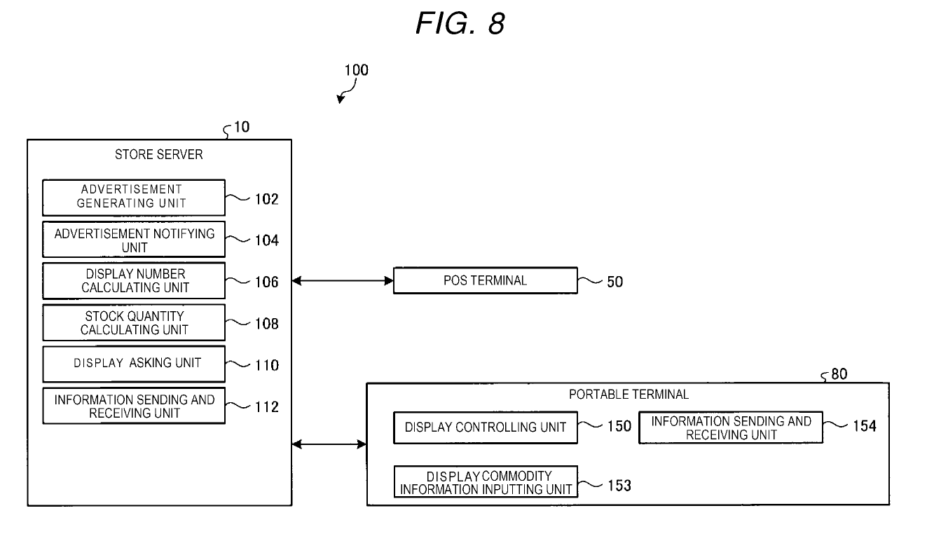

Next, a functional configuration of the real-time messaging system 100 will be described. FIG. 8 is a functional block diagram illustrating the functional components of the real-time messaging system 100. The plurality of POS terminals 50 and the plurality of portable terminals 80 are respectively provided, but in FIG. 8, in order to simplify the description, the real-time messaging system 100 includes one POS terminal 50 and one portable terminal 80, respectively.

As illustrated in FIG. 8, the CPU 12 (FIG. 4) operates in accordance with the control program P1, thereby, the control unit 18 of the store server 10 is configured to function as a display number calculating unit 106, a stock quantity calculating unit 108, a display asking unit 110, an information sending and receiving unit 112, an advertisement generating unit 102, and an advertisement notifying unit 104.

The display number calculating unit 106 calculates how many commodities are currently displayed on the store shelf of the store. Specifically, the display number calculating unit 106 obtains the display number of corresponding commodities at the time of opening the store, with reference to the commodity master file F1. Therefore, the display number calculating unit 106 calculates the current display number, by subtracting the number of the commodities of which the checkout processing has been performed in the POS terminal 50 from the obtained display number.

The stock quantity calculating unit 108 calculates the current stock quantity (quantity of the stock which is currently stocked in the backyard of the store) of the commodity. Specifically, the stock quantity calculating unit 108 obtains the stock quantity of the corresponding commodity at the time of opening the store, with reference to the commodity master file F1. Therefore, the stock quantity calculating unit 108 calculates the current stock quantity, by subtracting the number of the commodities that have been displayed on the store shelf up to now from the current stock quantity at the time of opening the store.

The display asking unit 110 sends a request to display more of the corresponding commodity, to the portable terminal 80 which is carried by the salesperson of the store, on condition that the display number of commodities is less than a predetermined value, and the current stock quantity of the commodity is not 0.

The information sending and receiving unit 112 performs sending and receiving of the information between the store server 10 and the POS terminal 50. Furthermore, the information sending and receiving unit 112 performs the sending and receiving of the information between the store server 10 and the portable terminal 80.

The advertisement generating unit 102 generates the display advertisement message relating to the display commodity, with reference to the display commodity information which is input at the timing of the displaying of the commodity.

The advertisement notifying unit 104 performs extraction of the notification destination of the display advertisement message, and notifies the notification destination of the display advertisement message. For example, the advertisement notifying unit 104 performs the extraction of the notification destination of the display advertisement message, with reference to the number of past purchased commodities per customer relating to the display commodity. For example, the advertisement notifying unit 104 performs the extraction of the notification destination of the display advertisement message, with reference to the customer rank per customer relating to the display commodity.

As illustrated in FIG. 8, the CPU 82 (FIG. 2) operates in accordance with the control program P4, thereby, the control unit 88 of the portable terminal 80 is configured to function as a display controlling unit 150, a display commodity information inputting unit 153, and an information sending and receiving unit 154. Although not illustrated in FIG. 8, all of the portable terminals 80 have the same functional configurations.

The display controlling unit 150 controls the information which is displayed on the display unit 94 (see FIG. 2) of the portable terminal 80. Specifically, the display controlling unit 150 displays a notification screen (which is not illustrated in the drawing) including the display asking information on the display unit 94 of the portable terminal 80.

The display commodity information inputting unit 153 receives the display commodity information relating to the display commodity which is input to the portable terminal 80, when the salesperson performs the displaying of the commodity. Here, the display commodity information is the information which is stored in the display commodity information table T1, and includes the commodity code f41 of the commodity of which the displaying is performed, the displaying date and time f42, the price cut f43, the discount rate f44, the quantity f45, the quantity limit f46, the advertisement priority customer f47, the number of past purchased commodities f48, and the immediate notification target f49.

The information sending and receiving unit 154 performs the sending and receiving of the information between the portable terminal 80 and the store server 10. Specifically, the display asking information, a deletion command of the display asking information, or the like is sent to the portable terminal 80 from the store server 10. The display commodity information or the like is sent to the store server 10 from the portable terminal 80.

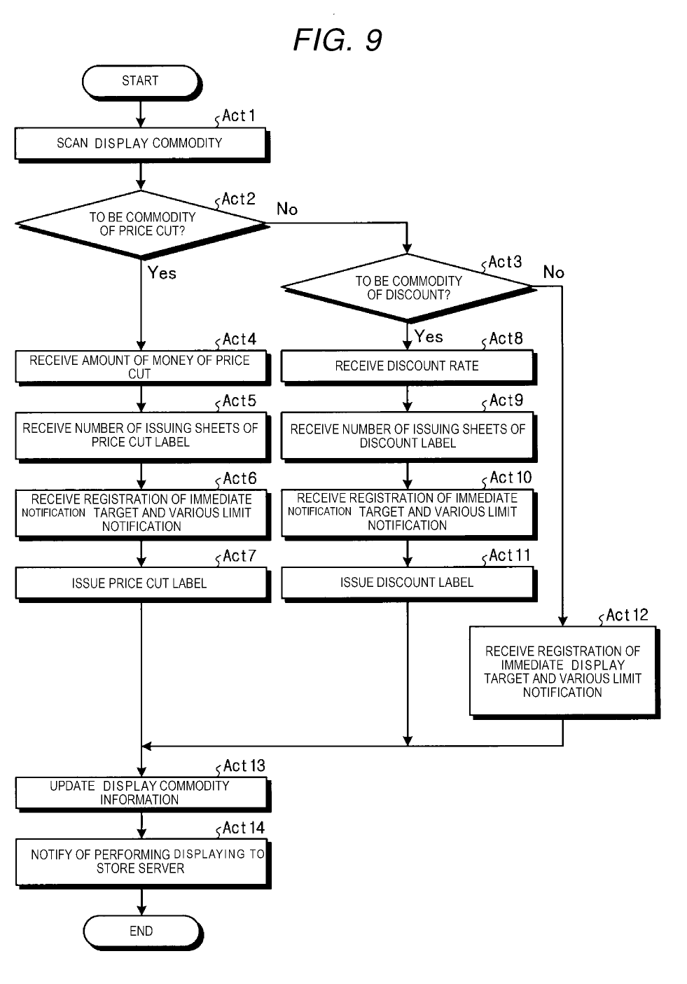

Next, display commodity information update processing which is executed by the display commodity information inputting unit 153 of the portable terminal 80 will be described. FIG. 9 is a flowchart illustrating a method of updating display commodity information.

As illustrated in FIG. 9, the display commodity information inputting unit 153 of the portable terminal 80 obtains the commodity code by performing scanning of the barcode which is attached to the commodity of the display target with a use of the scanner 93, in accordance with the command from the salesperson who performs the displaying of the commodity (Act 1).

When the amount of money of the price cut, and the number of sheets of a price cut label to be issued are input due to an input command from the salesperson who performs the displaying of the commodity, the display commodity information inputting unit 153 of the portable terminal 80 determines that the commodity of the display target is the commodity subjected to the price cut such as a time sale (Yes in Act 2), receives the amount of money of the price cut (Act 4), and receives the number of sheets of the price cut label to be issued (Act 5).

Subsequently, the display commodity information inputting unit 153 of the portable terminal 80 receives the registrations of the immediate notification target and various limit notifications (Act 6), and settles the display commodity information relating to the commodity which is currently being displayed. Here, the limit notification is the notification which is made such that the quantity limit is capable of being notified in the display advertisement by inputting that there is the limit on the quantity. Thereby, it is possible to prompt the customer to be able to visit the store immediately after the e-mail notification of the advertisement to the customer.

As another limit notification, the customer rank such as gold is input, thereby, the notification of the display advertisement may be performed only to a specific customer. As another limit notification, the number of past purchased commodities is input, thereby, the notification of the display advertisement may be performed only to the customer who is able to repeatedly purchase the same commodities.

Next, the portable terminal 80 issues the price cut label as the number of sheets of the price cut label to be issued which is input in Act 5 by the label printer 95 (Act 7), and the processing proceeds to Act 13.

On the other hand, when the discount rate, and the number of sheets of a discount label to be issued are input due to the input command from the salesperson who performs the displaying, the display commodity information inputting unit 153 of the portable terminal 80 determines that the commodity of the display target is the commodity of the discount such as a time sale (No in Act 2, Yes in Act 3), receives the discount rate (Act 8), and receives the quantity which becomes the number of sheets of the discount label to be issued (Act 9).

Subsequently, the display commodity information inputting unit 153 of the portable terminal 80 receives the registrations of the immediate notification target and various limit notifications (Act 10), and settles the display commodity information relating to the commodity which is currently being displayed. The limit notification is the same as that described in Act 6.

Next, the portable terminal 80 issues the discount label as the number of sheets of the discount label to be issued which is input in Act 9 (Act 11), and the processing proceeds to Act 13.

When the portable terminal 80 determines that the commodity of the display target is neither the commodity of the price cut nor the commodity of the discount (No in Act 2, No in Act 3), the portable terminal 80 registers the immediate notification target and various limit notifications (Act 12), and the processing proceeds to Act 13. The limit notification is the same as that described in Act 6.

In Act 13, the display commodity information inputting unit 153 of the portable terminal 80 updates the display commodity information of the display commodity information table T1 per input settlement of the display commodity information.

Next, the display commodity information inputting unit 153 of the portable terminal 80 notifies that the displaying is performed by sending the display commodity information of the display commodity information table T1 to the store server (Act 14), and requests the store server 10 to perform advertisement generating processing.

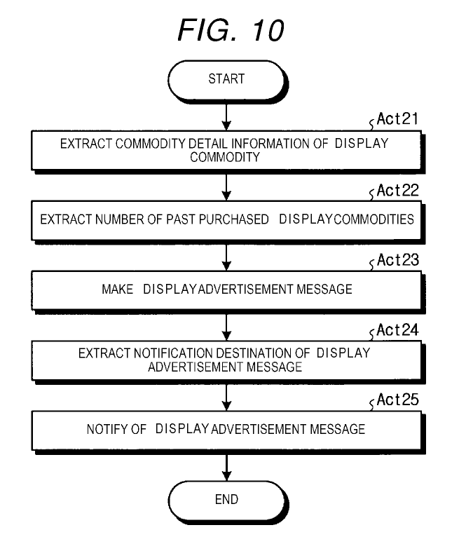

Next, the advertisement generating processing of the display commodity which is executed by the advertisement generating unit 102 and the advertisement notifying unit 104 of the store server 10 will be described. FIG. 10 is a flowchart illustrating a real-time messaging method according to an embodiment. When the store server 10 receives the request for the advertisement generating processing from the portable terminal 80, the store server 10 starts the advertisement generating processing for the display commodity.

As illustrated in FIG. 10, the advertisement generating unit 102 of the store server 10 extracts the display commodity information of the display commodity from the display master file F2 and the commodity master file F1 (Act 21).

Moreover, the advertisement generating unit 102 of the store server 10 extracts the number of past purchased commodities per customer relating to the display commodity from the customer master file F3 (Act 22).

Next, the advertisement generating unit 102 of the store server 10 makes the display advertisement message to be notified, by the display commodity information of the display commodity which is extracted in Act 21, and the number of past purchased commodities per customer relating to the display commodity which is extracted in Act 22 (Act 23).

In Act 23, the display advertisement message is made by combining the display commodity information of the commodity to be displayed and the number of past purchased commodities per customer relating to the display commodity with various messages. For example, when the displaying of the out-of-stock commodity is performed, replenishment information on the out-of-stock commodity is made as a display advertisement message. When the displaying of a new commodity is performed, the information on the new commodity is made as a display advertisement message. Hereinafter, a specific example of the display advertisement message will be described by using some cases.

### Example 1

Example 1 is a case in which the display master file F2 is set for “commodity A”, such that:
quantity limit: presence
advertisement priority customer: gold rank
number of past purchased commodities: 0 (no limit)
immediate notification target: 1
   In this case, the display advertisement message is: “Special information only for [gold rank member]. Just now, [commodity A] has been discounted by 100 yen. Please visit the store as soon as possible since there is a limit X on the quantity of [commodity A] that is subject to this discount.” Since “immediate notification target: 1” is set, the display advertisement message is immediately notified to the customer, thereby, the customer is able to purchase the desired commodity at low cost, and the store is capable of increasing an opportunity of a sales rise by reducing the quantity of the stock and the number of wastes.

### Example 2

Example 2 is a case in which the display master file F2 is set for “commodity B”, such that:
discount, quantity limit: none
advertisement priority customer: female
number of past purchased commodities: 0 (no limit)
immediate notification target: 1
   In this case, the display advertisement message is: “Special information only for [female]. Just now, [commodity B] is discounted by 20%. Please visit the store.” Since “immediate notification target: 1” is set, the display advertisement message is immediately notified to the customer, thereby, the customer is able to purchase the desired commodity at low cost, and the store is capable of increasing the opportunity of the sales rise by reducing the quantity of the stock and the number of wastes.

### Example 3

Example 3 is a case in which the display master file F2 is set for “commodity C” that is a fresh commodity which becomes the target of a timed sale, such that:
quantity limit: presence
advertisement priority customer: none (all the members)
number of past purchased commodities: 0 (no limit)
immediate notification target: 1
   In this case, the display advertisement message is: “Just now, the fresh [commodity C] has arrived. Please visit the store since the timed sale of 100 yen is performed from 16:00.” Since “immediate notification target: 1” is set, according to the display advertisement message, it is possible to notify the customer of that the commodity with good freshness is displayed, and the customer can purchase the fresh commodity based on the advertisement message.

### Example 4

Example 4 is a case in which the display master file F2 is set for “commodity D”, such that:
quantity limit: none
advertisement priority customer: none (all the members)
number of past purchased commodities: 10 or more
immediate notification target: 1
   In this case, the display advertisement message is: “[Commodity D] which is habitually used by [Dear. AA] has arrived again. Why don't you purchase the commodity on this occasion? The store looks forward to the visit.” The exclusive display advertisement message is notified to the customer who purchased the set number or more of a specific commodity in the past, thereby, it is possible to give a special sense to a specific customer. In addition, it is possible to prompt the repurchase of the same commodity.

After the display advertisement message is generated, the advertisement notifying unit 104 of the store server 10 performs the extraction of the notification destination of the display advertisement message (Act 24). The advertisement notifying unit 104 of the store server 10 obtains the notification destination of the display advertisement message from the information of the customer master file F3. When the advertisement priority customer is retained, the information is used for narrowing down the extraction of the notification destination.

After the notification destination of the display advertisement message is extracted, the advertisement notifying unit 104 of the store server 10 notifies of the display advertisement message to the notification destination (Act 25). Here, in a case of the commodity of which the flag of the immediate notification target is “1”, the advertisement notifying unit 104 of the store server 10 preferentially and immediately notifies of the display advertisement message for the commodity to the notification destination.

In this manner, according to the real-time messaging system 100 of one embodiment, since the customer is able to receive the information of the up-to-date commodity which is currently present in the store, by notifying the customer of the display advertisement message immediately at the timing of the displaying, it is possible to increase the opportunities of the store visit of the customer, and to increase the sales rise by prompting the customer who currently visits the store for the additional purchase. In addition, according to the real-time messaging system 100 of one embodiment, the display advertisement message is sent out in conjunction with the displaying; thereby, cases where the commodity is out of stock when the customer visits the store are reduced.

According to the real-time messaging system 100 of one embodiment, it is possible to enhance a satisfaction level of a specific customer, by notifying only the customer of high customer rank or the customer who purchased the same commodity in the past of the display advertisement message, or by notifying the customer of high customer rank or the customers who purchased the same commodity in the past of the display advertisement message more quickly than the normal customer.

Furthermore, according to the real-time messaging system 100 of one embodiment, since the display advertisement message is made with respect to the customer immediately at the timing of the displaying, there is no need for a store worker to perform the generation of the display advertisement message at the store every time, and it is possible to send out the advertisement effectively.

### EXAMPLES

1. There is a wish for commodity sales promotion from a manufacturer, and the commodity is capable of being bought at a unit price which is lower than a normal price. However, there is the wish for the sales promotion, and the commodity is bought at the timing which is different from that of normal placing of order, thereby, a state where the stock quantity of the store becomes large is made.

Therefore, in order to fulfill the wish of the sales promotion from the manufacturer, and to reduce the stock quantity of the store, the display advertisement message is sent to the customer immediately at the timing when the displaying of the commodity is performed, and the sales promotion of the commodity is performed.

2. The commodities are bought in large quantities from a manufacturer which is different from the normal manufacturer; thereby, it is possible to buy the commodity at a unit price which is cheap. However, since the commodity is bought at the timing which is different from that of the normal placing of order, the stock quantity of the stores becomes large.

Therefore, in order to reduce the stock quantity of the store, the display advertisement message is sent to the customer immediately at the timing when the displaying of the commodity is performed, and the sales promotion of the commodity is performed.

3. It is possible to buy the commodities which are not generally handled in large quantities.

Therefore, in order to reduce the stock quantity of the store, the display advertisement message is sent to the customer immediately at the timing when the displaying of the commodity is performed, and the sales promotion of the commodity is performed.

The display advertisement message is sent to the customer immediately at the timing when the displaying of the commodity is performed, and a sales number is confirmed, thereby, it is possible to analyze an interest of the customer on the commodity. Thereby, it is also possible to determine whether or not a periodic buy of a target commodity is performed.

4. When a new commodity is bought, it is found out that the stock quantity of the same old commodity much remains. In order to perform the sales promotion of the new commodity, the stock of the old commodity is wished to be eliminated.

Therefore, the display advertisement message is sent to the customer immediately at the timing when the displaying is performed by discounting the old commodity, and the sales promotion of the commodity is performed.

5. The commodities having expiry dates are bought in large quantities, due to a mistake of the placing of order.

Therefore, in order to reduce the stock quantity of the store, the display advertisement message is sent to the customer immediately at the timing when the displaying of the commodity is performed, and the sales promotion of the commodity is performed.

6. When the displaying is performed by adding a leaflet commodity, the sales number of today and the current stock quantity are confirmed, accordingly, the sales number becomes small in comparison with a plan.

Therefore, again, the display advertisement message is immediately sent to the customer, and the sales promotion of a specific commodity is performed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A real-time messaging system, comprising:
a store server configured to track items that are displayed on store shelves by item code and quantity and the items that are not displayed but available in inventory by item code and quantity; and
a plurality of portable terminals configured to provide the store server updates to the quantities of the items that are displayed and the items that are in inventory, when one or more items in the inventory are moved for display onto the store shelves and code and quantity of each of the moved items are input using the portable terminals,
wherein the store server, in response to the updates, generates a message in real-time regarding an item that has been moved for display and transmits the message to one or more target destinations.

2. The system according to claim 1, wherein the store server is configured to track information about customers and group the customers into at least a first group and a second group, and the message is transmitted to the customers in the first group but not the customers in the second group.

3. The system according to claim 2, wherein the message relates to a price cut or a discount of the item that has been moved for display and the customers in the first group are rated, as to the item, as higher priority relative to the customers in the second group.

4. The system according to claim 3, wherein the store server determines whether or not an immediacy flag of the item is set prior to transmitting the message in real-time to the customers in the first group.

5. The system according to claim 2, wherein the customers in the first group is all male or all female.

6. The system according to claim 2, wherein the customers in the first group has previously purchased the item has been moved for display a predetermined number of times or more.

7. The system according to claim 1, wherein the message is about a price cut or a discount of the item that has been moved for display.

8. The system according to claim 7, wherein the message further indicates the quantity of the item that has been moved for display that is subject to the price cut or the discount.

9. The system according to claim 1, wherein the message is about a replenishment of one of the items previously out-of-stock.

10. The system according to claim 1, further comprising:
a plurality of point-of-sale terminals that transmit sales data with the store server, wherein
the store server updates the quantities of the items that are displayed according to the sales data received from the point-sale terminals.
